(19) United States
(12) Patent Application Publication
(10) Pub. No.: US 2017/0353554 A1
(43) Pub. Date: Dec. 7, 2017

(54) MESSAGE TRANSMITTING METHOD AND DEVICE FOR A ROBOT OPERATING SYSTEM

(71) Applicant: BEIJING BAIDU NETCOM SCIENCE AND TECHNOLOGY CO., LTD., Beijing (CN)

(72) Inventors: Jingchao FENG, Beijing (CN); Liming XIA, Beijing (CN); Quan WANG, Beijing (CN); Ning QU, Beijing (CN); Zhuo CHEN, Beijing (CN)

(21) Appl. No.: 15/279,723

(22) Filed: Sep. 29, 2016

(30) Foreign Application Priority Data
Jun. 2, 2016 (CN) 201610390281.5

(51) Int. Cl. H04L 29/08; B25J 9/16; G06F 3/06

(52) U.S. Cl. CPC H04L 67/1097; G06F 3/067; G06F 3/0659; G06F 3/0647; B25J 9/161; G06F 3/0637; G06F 3/0619; G06F 3/064

(57) ABSTRACT

The present application discloses a message transmitting method and device for a robot operating system. A specific embodiment of the method comprises: searching by looping through a memory segment in a shared memory, by a transmitting node, a memory block having a memory block indicator comprising a writing mark of “writeable” and a reading mark of “0”; amending, by the transmitting node, the writing mark of the memory block indicator of the memory block searched out to indicate that the memory block is being written, and then writing data into the memory block searched out; and resetting, by the transmitting node, the writing mark of the memory block indicator of the memory block searched out to indicate that the memory block is writable after the data is written, releasing the memory block searched out and notifying a receiving node that the memory block searched out is readable. The embodiment can realize that transmitting nodes and receiving nodes may subsequently read or write data in a shared memory without interference.

### CROSS-REFERENCE TO RELATED APPLICATION

This application is related to and claims priority from Chinese Application No. 201610390281.5, filed on Jun. 2, 2016, entitled “MESSAGE TRANSMITTING METHOD AND DEVICE FOR A ROBOT OPERATING SYSTEM,” the entire disclosure of which is hereby incorporated by reference.

### TECHNICAL FIELD

The present application relates to the field of computer technology, specifically to the technical field of computer operating system, and more specifically to a message transmitting method and device for a robot operating system.

### BACKGROUND

The robot operating system (ROS) includes many nodes and topics. Each node is an independent process. The topic is the basis for establishing the connection between nodes. There are two kinds of nodes: transmitting nodes and receiving nodes. The transmitting nodes are responsible for transmitting the processed information, and the receiving nodes are responsible for receiving the information transmitted from the transmitting nodes and operating correspondingly according to a command (sometimes a node is both a transmitter and a receiver). When the connection between the nodes is established, the transmitting and receiving nodes perform the message transmission by sharing a memory.

Performing the message transmission by sharing a memory means that a plurality of publishing and receiving nodes use the same shared memory area simultaneously. Two typical problems are: 1) when a transmitting node is writing data into a shared memory area and another node is also reading/writing on this segment of the memory, the transmitting node may be interrupted, leading to an abnormal exit; 2) when a receiving node is reading a certain segment of the shared memory area and a transmitting node is also writing data into this section of the memory, the receiving node will read wrong information, leading to a wrong processing result and a wrong operating instruction. As a result, it remains a problem to be solved to synchronize the processes of these nodes such that they can subsequently read and write in the shared memory without interference.

### SUMMARY

One of the purposes of the present application is to provide a message transmitting method and device for a robot operating system, to solve the above technical problems mentioned in the background.

In the first aspect, the present application provides a message transmitting method for a robot operating system, comprising: searching by looping through a memory segment in a shared memory, by a transmitting node, a memory block having a memory block indicator comprising a writing mark of “writeable” and a reading mark of “0”, the memory segment comprising a plurality of memory blocks, wherein each memory block stores a memory block indicator comprising a writing mark indicating that the memory block is being written or writable and a reading mark indicating a number of receiving nodes which are reading the memory block; amending, by the transmitting node, the writing mark of the memory block indicator of the memory block searched out to indicate that the memory block is being written, and then writing data into the memory block searched out; and resetting, by the transmitting node, the writing mark of the memory block indicator of the memory block searched out to indicate that the memory block is writable after the data is written, releasing the memory block searched out and notifying a receiving node that the memory block searched out is readable.

In some embodiments, amending, by the transmitting node, the writing mark of the memory block indicator of the memory block searched out to indicate that the memory block is being written, and then writing data into the memory block searched out comprises: setting, by the transmitting node, a data mutex lock on the memory block indicator of the memory block searched out before amending, by the transmitting node, the writing mark of the memory block indicator of the memory block searched out to indicate that the memory block is being written; and releasing, by the transmitting node, the data mutex lock after amending the writing mark of the memory block indicator to indicate that the memory block is being written.

In some embodiments, resetting, by the transmitting node, the writing mark of the memory block indicator of the memory block searched out to indicate that the memory block is writable after the data is written comprises: setting, by the transmitting node, a data mutex lock on the memory block indicator of the memory block searched out before resetting, by the transmitting node, the writing mark of the memory block indicator of the memory block searched out to indicate that the memory block is writable; and releasing, by the transmitting node, the data mutex lock after resetting, by the transmitting node, the writing mark of the memory block indicator of the memory block searched out to indicate that the memory block is writable.

In the second aspect, the present application provides a message transmitting method for a robot operating system, comprising: determining, by a receiving node, whether a writing mark of a memory block indicator of a memory block indicated by a notification that the memory block is readable indicates that the memory block is writable, after the notification transmitted from a transmitting node is received by the receiving node, wherein a memory segment in a shared memory comprises a plurality of memory blocks, and each memory block stores a memory block indicator comprising a writing mark indicating that the memory block is being written or writable and a reading mark indicating a number of receiving nodes which are reading the memory block; reading, by the receiving node, data from the memory block, after adding 1 to a value indicated by the reading mark of the memory block indicator of the memory block, where the writing mark of the memory block indicator of the memory block indicated by the notification that the memory block is readable indicates that the memory block is writable; and subtracting, by the receiving node, 1 from the value indicated by the reading mark of the memory block indicator of the memory block, releasing the memory block, and notifying a transmitting node that the memory block is writeable, after reading the data.

In some embodiments, reading, by the receiving node, data from the memory block, after adding 1 to a value indicated by the reading mark of the memory block indicator of the memory block comprises: setting, by the receiving node, a data mutex lock on the memory block indicator of the memory block before adding 1 to a value indicated by the reading mark of the memory block indicator of the memory block; and releasing, by the receiving node, the data mutex lock after adding 1 to a value indicated by the reading mark of the memory block indicator of the memory block.

In some embodiments, subtracting, by the receiving node, 1 from the value indicated by the reading mark of the memory block indicator of the memory block after reading the data comprises: setting, by the receiving node, a data mutex lock on the memory block indicator of the memory block before subtracting, by the receiving node, 1 from the value indicated by the reading mark of the memory block indicator of the memory block; and releasing, by the receiving node, the data mutex lock after subtracting, by the receiving node, 1 from the value indicated by the reading mark of the memory block indicator of the memory block.

In the third aspect, the present application provides a message transmitting device for a robot operating system, comprising: a searching unit, configured to search by looping through a memory segment in a shared memory a memory block having a memory block indicator comprising a writing mark of “writeable” and a reading mark of “0”, the memory segment comprising a plurality of memory blocks, wherein each memory block stores a memory block indicator comprising a writing mark indicating that the memory block is being written or writable and a reading mark indicating a number of receiving nodes which are reading the memory block; a writing unit, configured to amend the writing mark of the memory block indicator of the memory block searched out to indicate that the memory block is being written, and then write data into the memory block searched out; and a reading and notifying unit, configured to reset the writing mark of the memory block indicator of the memory block searched out to indicate that the memory block is writable after the data is written, release the memory block searched out and notify a receiving node that the memory block searched out is readable.

In some embodiment, the writing unit further is further configured to: set a data mutex lock on the memory block indicator of the memory block searched out before amending the writing mark of the memory block indicator of the memory block searched out to indicate that the memory block is being written; and release the data mutex lock after amending the writing mark of the memory block indicator to indicate that the memory block is being written.

In some embodiment, the reading and notifying unit is further configured to: set a data mutex lock on the memory block indicator of the memory block searched out before resetting the writing mark of the memory block indicator of the memory block searched out to indicate that the memory block is writable; and release the data mutex lock after resetting the writing mark of the memory block indicator of the memory block searched out to indicate that the memory block is writable.

In the fourth aspect, the present application provides a message transmitting device for a robot operating system, comprising: a receiving unit, configured to receive a notification that a memory block is readable, which is transmitted from a transmitting node, and then determine whether a writing mark of a memory block indicator of the memory block indicated by the notification indicates that the memory block is writable, wherein a memory segment in a shared memory comprises a plurality of memory blocks, and each memory block stores a memory block indicator comprising a writing mark indicating that the memory block is being written or writable and a reading mark indicating a number of receiving nodes which are reading the memory block; a reading unit, configured to add 1 to a value indicated by the reading mark of the memory block indicator of the memory block, and then read data from the memory block, where the writing mark of the memory block indicator of the memory block indicated by the notification that the memory block is readable indicates that the memory block is writable; and a writing and notifying unit, configured to subtract 1 from the value indicated by the reading mark of the memory block indicator of the memory block, release the memory block, and notify a transmitting node that the memory block is writeable, after the data is read.

In some embodiment, the reading unit is further configured to: set a data mutex lock on the memory block indicator of the memory block before adding 1 to a value indicated by the reading mark of the memory block indicator of the memory block; and release the data mutex lock after adding 1 to a value indicated by the reading mark of the memory block indicator of the memory block.

In some embodiment, the writing and notifying unit is further configured to: set a data mutex lock on the memory block indicator of the memory block before subtracting 1 from the value indicated by the reading mark of the memory block indicator of the memory block; and release the data mutex lock after subtracting 1 from the value indicated by the reading mark of the memory block indicator of the memory block.

The message transmitting method and device for a robot operating system provided in the present application can effectively ensure that a memory block can be written only by one transmitting node or can be read by a plurality of receiving nodes at the same time by using a memory block indicator and a data mutex lock.

### BRIEF DESCRIPTION OF THE DRAWINGS

After reading detailed descriptions of non-limiting embodiments with reference to the following accompanying drawings, other features, objectives and advantages of the present application will be more apparent:

FIG. 1 is a schematic diagram of an exemplary system architecture to which the present application can be applied;

FIG. 2a is a flowchart of the message transmitting method for a robot operating system according to an embodiment of the present application;

FIG. 2b is a flowchart of the message transmitting method for a robot operating system according to anther embodiment of the present application;

FIG. 3 is a schematic diagram of an application scenario of the message transmitting method for a robot operating system according to the present application;

FIG. 4a is a flowchart of another embodiment of the message transmitting method for a robot operating system as shown in FIG. 2a;

FIG. 4b is a flowchart of another embodiment of the message transmitting method for a robot operating system as shown in FIG. 2b;

FIG. 5a is a structural schematic diagram of the message transmitting device for a robot operating system according to an embodiment of the present application;

FIG. 5b is a structural schematic diagram of the message transmitting device for a robot operating system according to an embodiment of the present application;

FIG. 6 is a structural schematic diagram of a computer system of a terminal device suitable for achieving the embodiment of the present application.

### DETAILED DESCRIPTION OF EMBODIMENTS

The present application is further described in detail through the accompanying drawing and the embodiment. It should be understood that, the specific embodiments described herein are merely used to explain the relevant invention, and are not intended to limit the present invention. In addition, it should be further noted that, in order to facilitate the description, merely the parts related to the relevant invention are shown in the accompanying drawings.

It should be noted that, the embodiments of the present application and features in the embodiments may be combined on a non-conflict basis. The present application will be described in detail through the accompanying drawings and the embodiments.

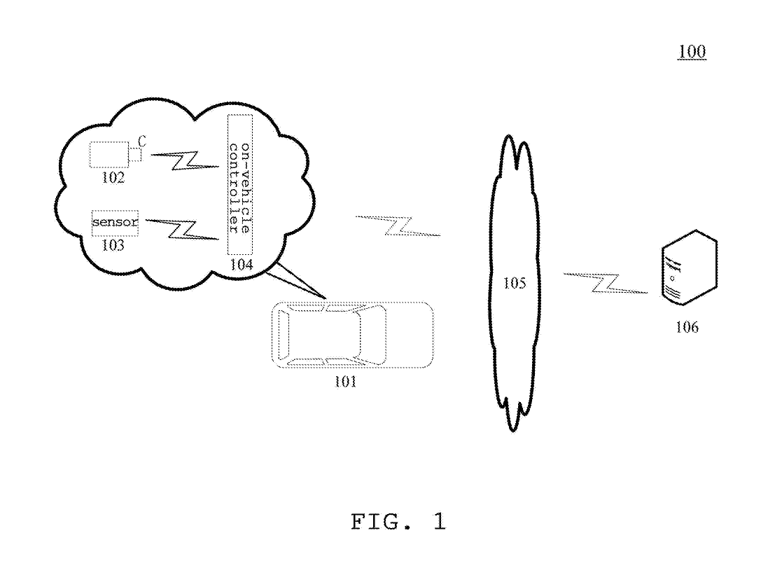

FIG. 1 shows an exemplary system architecture 100 of an embodiment of a message transmitting method or device for a robot operating system in which the present application can be applied.

As shown in FIG. 1, the system architecture 100 may comprise a driverless vehicle 101, a backend server 106 and a network 105. The network 105 is used for providing a medium of the communication link between the driverless vehicle 101 and the backend server 106. The network 105 can comprise various connection types, for example, a wired or wireless communication link or an optical fiber cable.

The backend server 106 may be an server which provides various services, for example, an backend map server which provides an online map to the driverless vehicle 101.

The driverless vehicle 101 may be equipped with collecting devices 102 and 103 and an on-vehicle controller 104. The collecting devices 102 and 103 may transmit the collected information to the on-vehicle controller 104 via various communication manners (for example, a wired or wireless communication link or an optical fiber cable). The collecting devices 102 and 103 may be various electronic devices for collecting the surrounding environment information, including but not limited to cameras and radars. The on-vehicle controller 104 adopts an improved robot operating system, and converts the surrounding environment information collected by the collecting devices 102, 103 and the map information provided by the backend server 106 into control information with the cooperation of nodes in the vehicle, so that the vehicle can run on the road smoothly and exactly.

It should be noted that the message transmitting method for a robot operating system provided in the embodiment of the present application is generally executed by the on-vehicle controller 104. Accordingly, the message transmitting device for a robot operating system is generally provided in the on-vehicle controller 104.

It should be understood that the numbers of the collecting devices, the driverless vehicle and the backend server in FIG. 1 are merely schematic. There may be any number of the collecting devices, the driverless vehicle and the backend server as required in practice. The on-vehicle controller may also be operated solely without a backend server and a network.

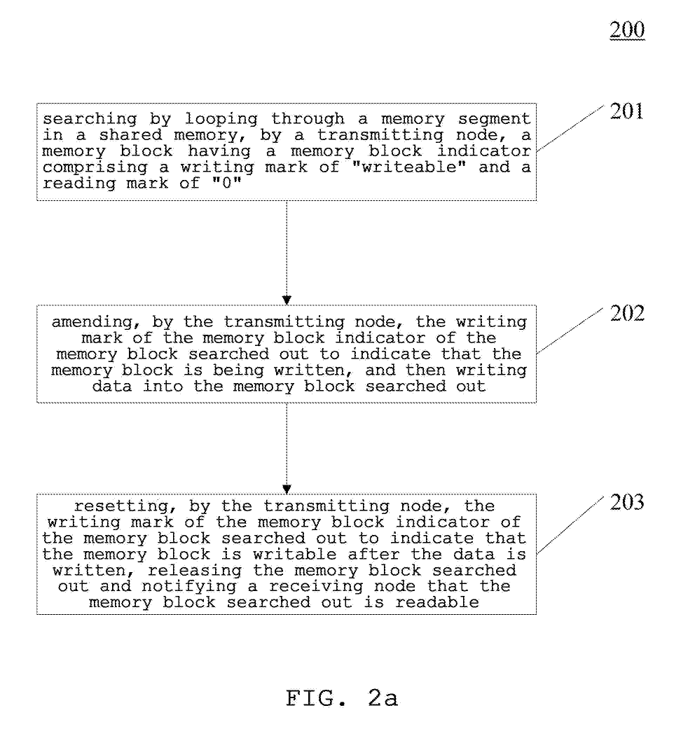

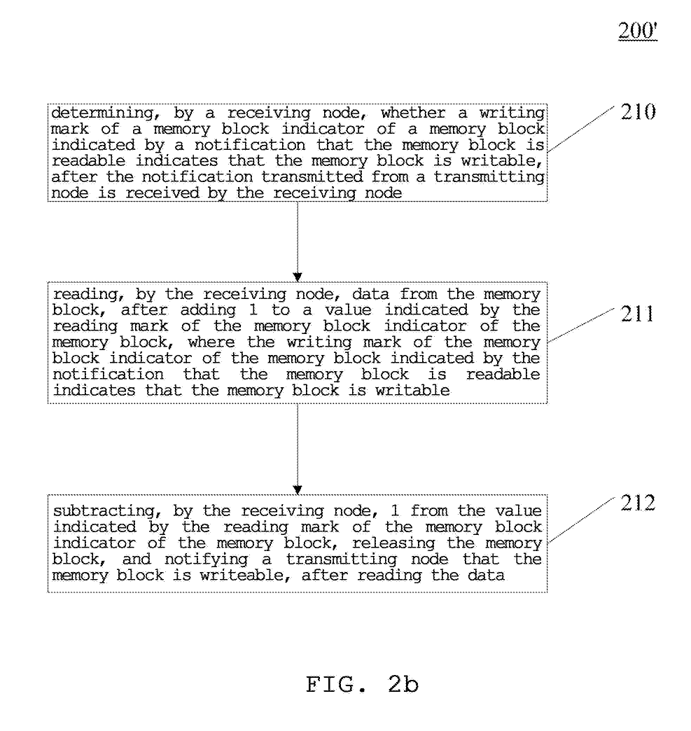

Further referring to FIG. 2a, a flowchart 200 of a message transmitting method for a robot operating system according to an embodiment of the present application is illustrated. The message transmitting method for a robot operating system comprises the following steps.

Step 201, searching by looping traversely in a memory segment in a shared memory, by a transmitting node, a memory block having a memory block indicator comprising a writing mark of “writeable” and a reading mark of “0”.

In this embodiment, the electronic devices on which the shared message transmitting method for a robot operating system is operated (for example, the on-vehicle controller shown in FIG. 1) transmit messages by using a shared memory. One memory segment comprises a plurality of memory blocks. Each memory block stores a memory block indicator comprising a writing mark indicating that the memory block is being written or writable and a reading mark indicating a number of receiving nodes which are reading the memory block. Each memory block has a sequence number. A transmitting node traverses by looping all the memory blocks in a memory segment before writing data, and determines whether a memory block is allowed to be written according to a memory block indicator of the memory block. For example, the writing mark of 0 of the memory block indicator means that the memory block is writeable at this time, and the writing mark of 1 of the memory block indicator means that a transmitting node is writing to the memory block at this time. The initial value of the reading mark of the memory block indicator is 0. 1 is added to the value when a receiving node is reading the memory block, and 1 is subtracted from the value after the reading of the receiving node is completed. There may be a plurality of receiving nodes to read data from the same memory block at the same time.

In some alternative implementations of this embodiment, a memory segment may comprise a memory segment indicator for storing the sequence number of the memory block into which data was written last time. For searching a writeable memory block next time, it can be started from the next memory block of the memory block having the sequence number.

Step 202, amending, by the transmitting node, the writing mark of the memory block indicator of the memory block searched out to indicate that the memory block is being written, and then writing data into the memory block searched out.

In this embodiment, the transmitting node needs to amend the memory block indicator of the memory block to lock a shared memory before writing data into the memory block, and other transmitting nodes or receiving nodes will not write data into the memory block or read data from the memory block at this time, so that these nodes may subsequently read or write data in a shared memory without interference.

Step 203, resetting, by the transmitting node, the writing mark of the memory block indicator of the memory block searched out to indicate that the memory block is writable after the data is written, releasing the memory block searched out and notifying a receiving node that the memory block searched out is readable.

In this embodiment, after the data is written, the transmitting node resets the writing mark of the memory block indicator of the memory block searched out to indicate that the memory block is writable, so as to release the shared memory for the receiving nodes to read data. The transmitting node releases the memory block searched out and notifies a receiving node that the memory block searched out is readable. For example, the writing mark of the memory block indicator is amended from 1 to 0 to indicate that the memory block is writeable.

With the method provided in the above embodiment of the present application, a receiving node which will read data from a memory block will be in a waiting state by using the memory block indicator, when data is being written into the memory block. The receiving node is allowed to read data, until the writing is completed.

Further referring to FIG. 2b, a flowchart 200′ of a message transmitting method for a robot operating system according to another embodiment of the present application is illustrated. The message transmitting method for a robot operating system comprises the following steps.

Step 210, determining, by a receiving node, whether a writing mark of a memory block indicator of a memory block indicated by a notification that the memory block is readable indicates that the memory block is writable, after the notification transmitted from a transmitting node is received by the receiving node.

In this embodiment, a memory segment in a shared memory comprises a plurality of memory blocks, and each memory block stores a memory block indicator comprising a writing mark indicating that the memory block is being written or writable and a reading mark indicating a number of receiving nodes which are reading the memory block. Before reading data from the memory block, the receiving node determines whether a transmitting node is writing data into the memory by checking the memory block indicator after receiving a notification that the memory block is readable, which is transmitted by a transmitting node. The receiving node will be in a waiting state if a transmitting node is writing data. The receiving node will be allowed to read data until the transmitting node has finished the data writing. The receiving node will be in a ready state, if there is no transmitting node which is writing data or until the transmitting node has finished the data writing.

Step 211, reading, by the receiving node, data from the memory block, after adding 1 to a value indicated by the reading mark of the memory block indicator of the memory block, where the writing mark of the memory block indicator of the memory block indicated by the notification that the memory block is readable indicates that the memory block is writable.

In this embodiment, the receiving node in the ready state amends the corresponding memory block indicator, and reads data from the memory after the successful amending. There may be a plurality of receiving nodes to read data from the same memory block at the same time.

Step 212, subtracting, by the receiving node, 1 from the value indicated by the reading mark of the memory block indicator of the memory block, releasing the memory block, and notifying a transmitting node that the memory block is writeable, after reading the data.

In this embodiment, after the data reading is completed, the memory block indicator is reset, the memory block is released, and transmitting nodes are notified that the memory block is writeable.

With the method provided in the above embodiment of the present application, during data in a memory block is read, it can be ensured that the memory block will not be accessed by other transmitting nodes by using a memory block indicator, thereby ensuring that the memory block will not be accessed by other nodes, and ensuring the synchronization of information to be read.

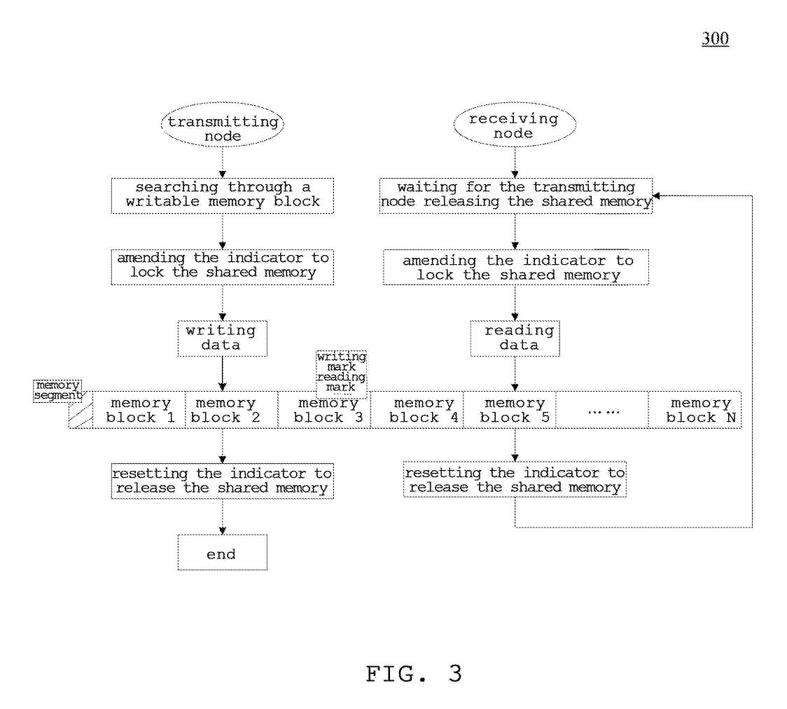

Further referring to FIG. 3, it is a schematic diagram of an application scenario of the message transmitting method for a robot operating system according to the present application. In the application scenario as shown in FIG. 3, a transmitting node traversely searches out a writable memory block 2 (the writing mark of the memory block indicator indicates that the memory block is writeable and the reading mark indicates “0”), and amends the memory block indicator as “writing” to lock the shared memory. Then, the transmitting node writes data into the memory block 2. Then, the transmitting node resets the memory block indicator of the memory block 2 as writeable to release the shared memory, releases the memory block 2, and notifies receiving nodes that the memory block 2 is readable. While the transmitting node performs an operation on the memory block 2, the receiving node reads data from another memory block. After receiving a notification that the memory block 5 is readable, the receiving node determines whether the writing mark of the memory block indicator of the memory block 5 indicates “writeable”. If it is writeable, the receiving node reads data from the memory block 5 after adding 1 to the value of the reading mark of the memory block indicator of the memory block 5. Then, the receiving node subtracts 1 from the value of the reading mark of the memory block indicator of the memory block 5 to release the shared memory, after reading data is completed.

With the method provided in the above embodiment of the present application, it can be ensured that a memory block is writeable only for one transmitting node or is readable for a plurality of receiving nodes at the same time by using a memory block indicator, thereby achieving the synchronization for transmitting-receiving nodes.

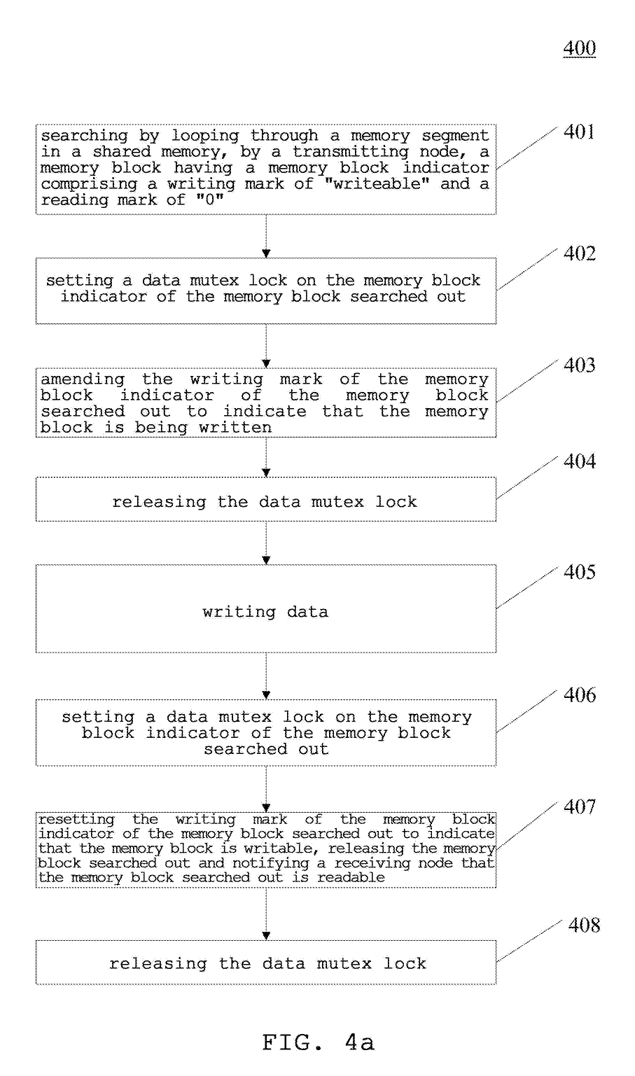

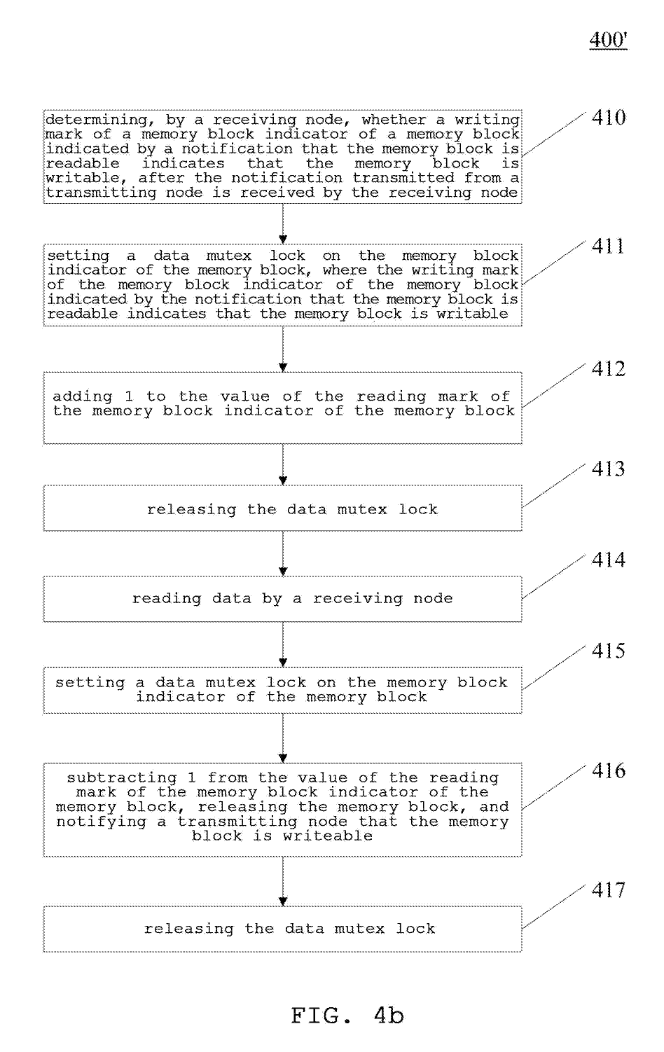

Further referring to FIG. 4b, a flowchart 400 of another embodiment of the message transmitting method for a robot operating system is illustrated. The message transmitting method for a robot operating system comprises the following steps.

Step 401, searching by looping traversely in a memory segment in a shared memory, by a transmitting node, a memory block having a memory block indicator comprising a writing mark of “writeable” and a reading mark of “0”.

The step is substantially the same as step 201, and will not be discussed in further detail here.

Step 402, setting a data mutex lock on the memory block indicator of the memory block searched out.

In this embodiment, the transmitting node sets a data mutex lock on the memory block indicator of the memory block searched out before amending the writing mark of the memory block indicator of the memory block searched out to indicate that the memory block is being written.

The data mutex lock serves to ensure the normal use of the memory block indicator. Since the amending of a memory block indicator is not an element operation, the memory block indicator may be used by other nodes while it is amended by a node, which will lead to abnormal writing and reading, or a wrong instruction. In order to ensure that the memory block indicator will not be amended by other nodes during its use, a data mutex lock method is introduced.

A data mutex lock operation is used in a piece of code, when the transmitting-receiving nodes is to amend a memory block indicator. At the same time, only one node can control the data mutex lock, and the node realizing the locked state can operate the shared memory. If another node will access a locked shared memory, the other node will be suspended until the node setting the data mutex lock releases the data mutex lock. The suspended node can have the right to access the shared memory until the node controlling the data mutex lock amends the memory block indicator to release the data mutex lock, and will also perform a locking operation during its accessing, so as to prevent the memory block indicator from being tampered by other nodes.

Step 403, amending the writing mark of the memory block indicator of the memory block searched out to indicate that the memory block is being written.

In this embodiment, the memory block indicator is amended to indicate that the memory block is being written, after a data mutex lock is set on the memory block indicator of the memory block searched out.

Step 404, releasing the data mutex lock.

In this embodiment, the data mutex lock is released after the memory block indicator is amended.

Step 405, writing data.

In this embodiment, data is written into the memory block after the memory block indicator is amended to indicate that the memory block is being written.

Step 406, setting a data mutex lock on the memory block indicator of the memory block searched out.

The step 406 is substantially same as step 402, and will not be discussed in further detail here.

Step 407, resetting the writing mark of the memory block indicator of the memory block searched out to indicate that the memory block is writable, releasing the memory block searched out and notifying a receiving node that the memory block searched out is readable.

In this embodiment, the transmitting node resets the writing mark of the memory block indicator of the memory block searched out to indicate that the memory block is writable after the data is written, releases the memory block searched out, and notifies a receiving node that the memory block searched out is readable.

Step 408, releasing the data mutex lock.

The step 408 is substantially same as step 404, and will not be discussed in further detail here.

As can be seen from FIG. 4a, the flowchart 400 of the message transmitting method for a robot operating system in this embodiment emphasizes the step of setting a data mutex lock on the memory block indicator, compared to the embodiment shown in FIG. 2a. As a result, the implementation described in this embodiment can prevent the memory block indicator from being tampered by other nodes, so as to ensure the correctness of the whole message transmitting method.

Further referring to FIG. 4b, a flowchart 400′ of another embodiment of the message transmitting method for a robot operating system is illustrated. The flowchart 400′ of the message transmitting method for a robot operating system comprises the following steps.

Step 410, determining, by a receiving node, whether a writing mark of a memory block indicator of a memory block indicated by a notification that the memory block is readable indicates that the memory block is writable, after the notification transmitted from a transmitting node is received by the receiving node.

The step 410 is substantially same as step 210, and will not be discussed in further detail here.

Step 411, setting a data mutex lock on the memory block indicator of the memory block, where the writing mark of the memory block indicator of the memory block indicated by the notification that the memory block is readable indicates that the memory block is writable.

In this embodiment, a receiving node, after receiving a notification that the memory block is readable, determines whether data can be read from the memory block according to the writing mark of the memory block indicator of the memory block indicated in the notification. That is, when the writing mark indicates “writeable”, it is needed to amend the memory block indicator before the data is read. It is needed to set a data mutex lock on the indicator before the indicator is amended in order to prevent the memory block indicator from being tampered by other nodes.

Step 412, adding 1 to the value of the reading mark of the memory block indicator of the memory block.

In this embodiment, the initial value of the reading mark of the memory block indicator of the memory block is 0. 1 is added to the value when a receiving node reads data from the memory block. There may be a plurality of receiving nodes to read data from the memory block at the same time. As a result, the value of the reading mark of the memory block indicator of the memory block is accumulated according to the number of the receiving nodes reading from the memory block.

Step 413, releasing the data mutex lock.

In this embodiment, the data mutex lock is released after the memory block indicator is amended.

Step 414, reading data by a receiving node.

In this embodiment, the receiving node reads data after the memory block indicator is amended.

Step 415, setting a data mutex lock on the memory block indicator of the memory block.

In this embodiment, it is needed to amend the memory block indicator of the memory block after the data is read. It is needed to set a data mutex lock on the indicator before the indicator is amended in order to prevent the memory block indicator from being tampered by other nodes.

Step 416, subtracting 1 from the value of the reading mark of the memory block indicator of the memory block, releasing the memory block, and notifying a transmitting node that the memory block is writeable.

In this embodiment, it is needed to subtract 1 from the value of the reading mark of the memory block indicator of the memory block after the data is read. If all receiving nodes have completed reading data at a certain time, the value of the reading mark of the memory block indicator of the memory block is 0. At this time, the memory block is released, and the receiving nodes release the memory block and notify transmitting nodes that the memory block is writeable.

Step 417, releasing the data mutex lock.

In this embodiment, the data mutex lock is released after the memory block indicator is amended.

As can be seen from FIG. 4b, the flowchart 400′ of the message transmitting method for a robot operating system in this embodiment emphasizes the step of setting a data mutex lock on the memory block indicator, compared to the embodiment shown in FIG. 2b. As a result, the implementation described in this embodiment can prevent the memory block indicator from being tampered by other nodes, so as to ensure the correctness of the whole message transmitting method.

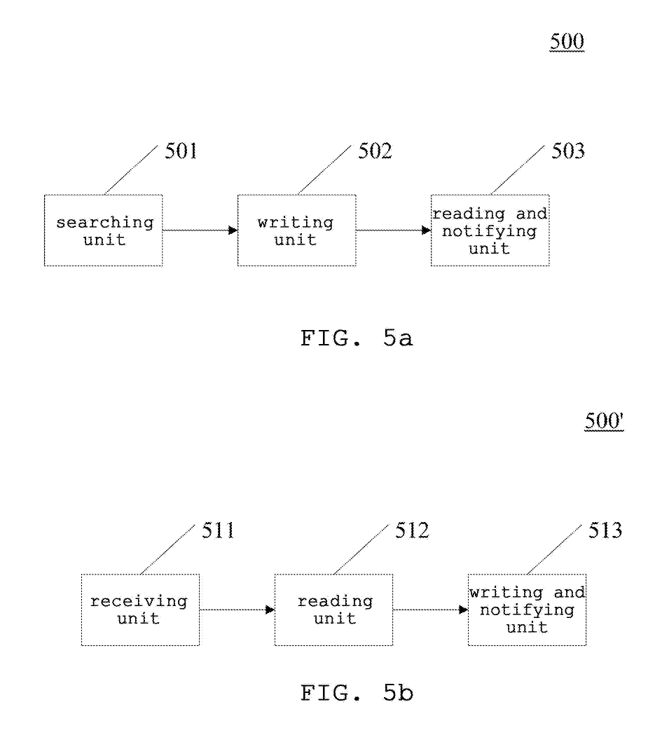

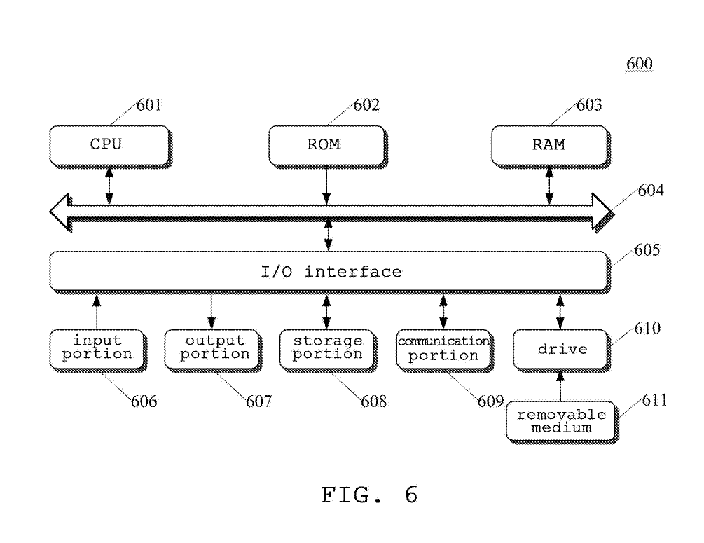

Further referring to FIG. 5a, which is an implementation of the methods shown in the above-mentioned figures, the present application provides an embodiment of a message transmitting device for a robot operating system. The device embodiment corresponds to the method embodiment shown in FIG. 2a, and may be applied to various electronic devices.

As illustrated in FIG. 5a, the message transmitting device 500 for a robot operating system in this embodiment comprises: a searching unit 501, a writing unit 502 and a reading and notifying unit 503. The searching unit 501 is configured to search by looping through a memory segment in a shared memory a memory block having a memory block indicator comprising a writing mark of “writeable” and a reading mark of “0”, the memory segment comprising a plurality of memory blocks, wherein each memory block stores a memory block indicator comprising a writing mark indicating that the memory block is being written or writable and a reading mark indicating a number of receiving nodes which are reading the memory block. The writing unit 502 is configured to amend the writing mark of the memory block indicator of the memory block searched out to indicate that the memory block is being written, and then write data into the memory block searched out. The reading and notifying unit 503 is configured to reset the writing mark of the memory block indicator of the memory block searched out to indicate that the memory block is writable after the data is written, release the memory block searched out and notify a receiving node that the memory block searched out is readable.

In alternative implementations in this embodiment, the writing unit 502 is further configured to: set a data mutex lock on the memory block indicator of the memory block searched out before amending the writing mark of the memory block indicator of the memory block searched out to indicate that the memory block is being written; and release the data mutex lock after amending the writing mark of the memory block indicator to indicate that the memory block is being written.

In alternative implementations in this embodiment, the reading and notifying unit 503 is further configured to: set a data mutex lock on the memory block indicator of the memory block searched out before resetting the writing mark of the memory block indicator of the memory block searched out to indicate that the memory block is writable; and release the data mutex lock after resetting the writing mark of the memory block indicator of the memory block searched out to indicate that the memory block is writable.

Further referring to FIG. 5b, which is an implementation of the methods shown in the above-mentioned figures, the present application provides an embodiment of a message transmitting device for a robot operating system. The device embodiment corresponds to the method embodiment shown in FIG. 2b, and may be applied to various electronic devices.

As illustrated in FIG. 5b, the message transmitting device 500′ for a robot operating system in this embodiment comprises: a receiving unit 511, a reading unit 512 and a writing and notifying unit 513. The receiving unit 511 is configured to receive a notification that a memory block is readable, which is transmitted from a transmitting node, and then determine whether a writing mark of a memory block indicator of the memory block indicated by the notification indicates that the memory block is writable, wherein a memory segment in a shared memory comprises a plurality of memory blocks, and each memory block stores a memory block indicator comprising a writing mark indicating that the memory block is being written or writable and a reading mark indicating a number of receiving nodes which are reading the memory block. The reading unit 512 is configured to add 1 to a value indicated by the reading mark of the memory block indicator of the memory block, and then read data from the memory block, where the writing mark of the memory block indicator of the memory block indicated by the notification that the memory block is readable indicates that the memory block is writable. The writing and notifying unit 513 is configured to subtract 1 from the value indicated by the reading mark of the memory block indicator of the memory block, release the memory block, and notify a transmitting node that the memory block is writeable, after the data is read.

In alternative implementations in this embodiment, the reading unit 512 is further configured to: set a data mutex lock on the memory block indicator of the memory block before adding 1 to a value indicated by the reading mark of the memory block indicator of the memory block; and release the data mutex lock after adding 1 to a value indicated by the reading mark of the memory block indicator of the memory block.

In alternative implementations in this embodiment, the writing and notifying unit 513 is further configured to: set a data mutex lock on the memory block indicator of the memory block before subtracting 1 from the value indicated by the reading mark of the memory block indicator of the memory block; and release the data mutex lock after subtracting 1 from the value indicated by the reading mark of the memory block indicator of the memory block.

Referring to FIG. 6, a schematic structural diagram of a computer system 600 adapted to implement a terminal apparatus of the embodiments of the present application is shown.

As shown in FIG. 6, the computer system X00 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to an embodiment of the present disclosure, the process described above with reference to FIG. 2 may be implemented in a computer software program. For example, an embodiment of the present disclosure includes a computer program product, which comprises a computer program that is tangibly embedded in a machine-readable medium. The computer program comprises program codes for executing the method of FIG. 2. In such an embodiment, the computer program may be downloaded and installed from a network via the communication portion 609, and/or may be installed from the removable media 611.

The flowcharts and block diagrams in the figures illustrate architectures, functions and operations that may be implemented according to the system, the method and the computer program product of the various embodiments of the present invention. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flowcharts and/or a combination of the blocks may be implemented by a dedicated hardware-based system executing specific functions or operations, or by a combination of a dedicated hardware and computer instructions.

The units or modules involved in the embodiments of the present application may be implemented by way of software or hardware. The described units or modules may also be provided in a processor, for example, described as: a processor, comprising a searching unit, a writing unit, and a reading and notifying unit, where the names of these units or modules are not considered as a limitation to the units or modules. For example, the searching unit may also be described as “a unit for searching by looping through a memory segment in a shared memory a memory block having a memory block indicator comprising a writing mark of ‘writeable’ and a reading mark of ‘0’”.

In another aspect, the present application further provides a computer readable storage medium. The computer readable storage medium may be the computer readable storage medium included in the apparatus in the above embodiments, or a stand-alone computer readable storage medium which has not been assembled into the apparatus. The computer readable storage medium stores one or more programs. The programs are used by one or more processors to: search by looping through a memory segment in a shared memory, by a transmitting node, a memory block having a memory block indicator comprising a writing mark of “writeable” and a reading mark of “0”, the memory segment comprising a plurality of memory blocks, wherein each memory block stores a memory block indicator comprising a writing mark indicating that the memory block is being written or writable and a reading mark indicating a number of receiving nodes which are reading the memory block; amend, by the transmitting node, the writing mark of the memory block indicator of the memory block searched out to indicate that the memory block is being written, and then write data into the memory block searched out; and reset, by the transmitting node, the writing mark of the memory block indicator of the memory block searched out to indicate that the memory block is writable after the data is written, release the memory block searched out and notify a receiving node that the memory block searched out is readable.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A message transmitting method for a robot operating system, comprising:
searching by looping through a memory segment of a shared memory, by a transmitting node, a memory block having a memory block indicator comprising a writing mark of “writeable” and a reading mark of “0”, the memory segment comprising a plurality of memory blocks, each memory block storing a memory block indicator comprising a writing mark indicating that the memory block is being written or writable and a reading mark indicating a number of receiving nodes which are reading the memory block;
amending, by the transmitting node, the writing mark of the memory block indicator of the memory block searched out to indicate that the memory block is being written, and then writing data into the memory block searched out; and
resetting, by the transmitting node, the writing mark of the memory block indicator of the memory block searched out to indicate that the memory block is writable after the data is written, releasing the memory block searched out and notifying a receiving node that the memory block searched out is readable.

2. The message transmitting method for a robot operating system according to claim 1, wherein amending, by the transmitting node, the writing mark of the memory block indicator of the memory block searched out to indicate that the memory block is being written, and then writing data into the memory block searched out comprises:
setting, by the transmitting node, a data mutex lock on the memory block indicator of the memory block searched out before amending, by the transmitting node, the writing mark of the memory block indicator of the memory block searched out to indicate that the memory block is being written; and
releasing, by the transmitting node, the data mutex lock after amending the writing mark of the memory block indicator to indicate that the memory block is being written.

3. The message transmitting method for a robot operating system according to claim 1, wherein resetting, by the transmitting node, the writing mark of the memory block indicator of the memory block searched out to indicate that the memory block is writable after the data is written comprises:
setting, by the transmitting node, a data mutex lock on the memory block indicator of the memory block searched out before resetting, by the transmitting node, the writing mark of the memory block indicator of the memory block searched out to indicate that the memory block is writable; and
releasing, by the transmitting node, the data mutex lock after resetting, by the transmitting node, the writing mark of the memory block indicator of the memory block searched out to indicate that the memory block is writable.

4. The message transmitting method for a robot operating system according to claim 2, wherein resetting, by the transmitting node, the writing mark of the memory block indicator of the memory block searched out to indicate that the memory block is writable after the data is written comprises:
setting, by the transmitting node, a data mutex lock on the memory block indicator of the memory block searched out before resetting, by the transmitting node, the writing mark of the memory block indicator of the memory block searched out to indicate that the memory block is writable; and
releasing, by the transmitting node, the data mutex lock after resetting, by the transmitting node, the writing mark of the memory block indicator of the memory block searched out to indicate that the memory block is writable.

5. A message transmitting method for a robot operating system, comprising:
determining, by a receiving node, whether a writing mark of a memory block indicator of a memory block indicated by a notification that the memory block is readable indicates that the memory block is writable, after the notification transmitted from a transmitting node is received by the receiving node, wherein a memory segment in a shared memory comprises a plurality of memory blocks, and each memory block stores a memory block indicator comprising a writing mark indicating that the memory block is being written or writable and a reading mark indicating a number of receiving nodes which are reading the memory block;
reading, by the receiving node, data from the memory block, after adding 1 to a value indicated by the reading mark of the memory block indicator of the memory block, where the writing mark of the memory block indicator of the memory block indicated by the notification that the memory block is readable indicates that the memory block is writable; and
subtracting, by the receiving node, 1 from the value indicated by the reading mark of the memory block indicator of the memory block, releasing the memory block, and notifying a transmitting node that the memory block is writeable, after reading the data.

6. The message transmitting method for a robot operating system according to claim 5, wherein reading, by the receiving node, data from the memory block, after adding 1 to a value indicated by the reading mark of the memory block indicator of the memory block comprises:
setting, by the receiving node, a data mutex lock on the memory block indicator of the memory block before adding 1 to a value indicated by the reading mark of the memory block indicator of the memory block; and
releasing, by the receiving node, the data mutex lock after adding 1 to a value indicated by the reading mark of the memory block indicator of the memory block.

7. The message transmitting method for a robot operating system according to claim 5, wherein subtracting, by the receiving node, 1 from the value indicated by the reading mark of the memory block indicator of the memory block after reading the data comprises:
setting, by the receiving node, a data mutex lock on the memory block indicator of the memory block before subtracting, by the receiving node, 1 from the value indicated by the reading mark of the memory block indicator of the memory block; and
releasing, by the receiving node, the data mutex lock after subtracting, by the receiving node, 1 from the value indicated by the reading mark of the memory block indicator of the memory block.

8. The message transmitting method for a robot operating system according to claim 6, wherein subtracting, by the receiving node, 1 from the value indicated by the reading mark of the memory block indicator of the memory block after reading the data comprises:
setting, by the receiving node, a data mutex lock on the memory block indicator of the memory block before subtracting, by the receiving node, 1 from the value indicated by the reading mark of the memory block indicator of the memory block; and
releasing, by the receiving node, the data mutex lock after subtracting, by the receiving node, 1 from the value indicated by the reading mark of the memory block indicator of the memory block.

9. A message transmitting device for a robot operating system, comprising:
a searching unit, configured to search by looping through a memory segment in a shared memory a memory block having a memory block indicator comprising a writing mark of “writeable” and a reading mark of “0”, the memory segment comprising a plurality of memory blocks, wherein each memory block stores a memory block indicator comprising a writing mark indicating that the memory block is being written or writable and a reading mark indicating a number of receiving nodes which are reading the memory block;
a writing unit, configured to amend the writing mark of the memory block indicator of the memory block searched out to indicate that the memory block is being written, and then write data into the memory block searched out; and
a reading and notifying unit, configured to reset the writing mark of the memory block indicator of the memory block searched out to indicate that the memory block is writable after the data is written, release the memory block searched out and notify a receiving node that the memory block searched out is readable.

10. The message transmitting device for a robot operating system according to claim 9, wherein the writing unit is further configured to:
set a data mutex lock on the memory block indicator of the memory block searched out before amending the writing mark of the memory block indicator of the memory block searched out to indicate that the memory block is being written; and
release the data mutex lock after amending the writing mark of the memory block indicator to indicate that the memory block is being written.

11. The message transmitting device for a robot operating system according to claim 9, wherein the reading and notifying unit is further configured to:
set a data mutex lock on the memory block indicator of the memory block searched out before resetting the writing mark of the memory block indicator of the memory block searched out to indicate that the memory block is writable; and
release the data mutex lock after resetting the writing mark of the memory block indicator of the memory block searched out to indicate that the memory block is writable.

12. The message transmitting device for a robot operating system according to claim 10, wherein the reading and notifying unit is further configured to:
set a data mutex lock on the memory block indicator of the memory block searched out before resetting the writing mark of the memory block indicator of the memory block searched out to indicate that the memory block is writable; and
release the data mutex lock after resetting the writing mark of the memory block indicator of the memory block searched out to indicate that the memory block is writable.

13. A message transmitting device for a robot operating system, comprising:
a receiving unit, configured to receive a notification that a memory block is readable, which is transmitted from a transmitting node, and then determine whether a writing mark of a memory block indicator of the memory block indicated by the notification indicates that the memory block is writable, wherein a memory segment in a shared memory comprises a plurality of memory blocks, and each memory block stores a memory block indicator comprising a writing mark indicating that the memory block is being written or writable and a reading mark indicating a number of receiving nodes which are reading the memory block;
a reading unit, configured to add 1 to a value indicated by the reading mark of the memory block indicator of the memory block, and then read data from the memory block, where the writing mark of the memory block indicator of the memory block indicated by the notification that the memory block is readable indicates that the memory block is writable; and
a writing and notifying unit, configured to subtract 1 from the value indicated by the reading mark of the memory block indicator of the memory block, release the memory block, and notify a transmitting node that the memory block is writeable, after the data is read.

14. The message transmitting device for a robot operating system according to claim 13, wherein the reading unit is further configured to:
set a data mutex lock on the memory block indicator of the memory block before adding 1 to a value indicated by the reading mark of the memory block indicator of the memory block; and
release the data mutex lock after adding 1 to a value indicated by the reading mark of the memory block indicator of the memory block.

15. The message transmitting device for a robot operating systems according to claim 13, wherein the writing and notifying unit is further configured to:
set a data mutex lock on the memory block indicator of the memory block before subtracting 1 from the value indicated by the reading mark of the memory block indicator of the memory block; and
release the data mutex lock after subtracting 1 from the value indicated by the reading mark of the memory block indicator of the memory block.

16. The message transmitting device for a robot operating systems according to claim 14, wherein the writing and notifying unit is further configured to:
set a data mutex lock on the memory block indicator of the memory block before subtracting 1 from the value indicated by the reading mark of the memory block indicator of the memory block; and
release the data mutex lock after subtracting 1 from the value indicated by the reading mark of the memory block indicator of the memory block.
